(19) United States
(12) Patent Application Publication
(10) Pub. No.: US 2014/0368007 A1
(43) Pub. Date: Dec. 18, 2014

(54) FASTENING MEMBER

(71) Applicant: John E. Cobb, Tyler, TX (US)

(72) Inventor: John E. Cobb, Tyler, TX (US)

(21) Appl. No.: 13/920,245

(22) Filed: Jun. 18, 2013

(51) Int. Cl. B62J 1/08

(52) U.S. Cl. CPC B62J 1/08
USPC 297/214; 297/463.1

(57) ABSTRACT

A fastening member is attached to a bicycle saddle having a base, a cushion, and a cover. The base has a lower base surface, and an outer lip. The fastening member is attached to the lower base and comprises arm members extending adjacent to the outer lip, a central portion separating the arm members, and a contoured housing member extending from the central portion. The arm members, central portion, and contoured housing member exist as a solid contiguous element. The contoured housing member comprises a receptacle for receiving support rails, and foundation surfaces for attachment of the fastening member to the base. The receptacle extends as a concave channel into the contoured housing member, separated from the foundation surfaces. The cover fits tautly over the base and cushion and is secured to the lower base surface. The cover extends between the fastening member and lower base surface.

### CROSS REFERENCE TO RELATED APPLICATIONS

This application contains subject matter related to subject matter contained in co-pending U.S. Ser. No. 29/458,263 (docket ECSJC05), filed Jun. 18, 2013 and incorporated herein by reference.

### BACKGROUND

The present invention relates to bicycle saddles and, more particularly, to a fastening member attached underneath a bicycle saddle.

Bicycle saddles typically integrate a base, a cushion, cover, and a support rail. The base is generally made of resilient plastic material, and forms the lower part of the seat. The cushion is often glued or secured to the base, and provides comfort for the rider. The cover extends around the cushion and is secured to the lower portion of the base. The cover is often constructed of nylon, leather, kevlar, or other fabric. Conventionally, the cover is secured to the lower portion of the base by glue and/or staples. The cover is cut and trimmed such that it does not protrude. The support rail may be affixed to the base and connected to a bicycle frame.

During the life of the saddle, the staples and glue holding the cover may become loose, allowing the cover to detach at certain points. Additionally, the fabric of the cover may rip or become untucked around the staples, thereby causing the fabric to protrude from the base.

It is desirable to cover the fabric of such that it does not tear from its attachment point to the base. Some bicycle saddles may provide “bumpers,” which include small plastic inserts attached to the nose, back and underside, of the saddle. However, such bumpers are entirely cosmetic and provide no structural support for effectively securing the cover to the base. Moreover, such bumpers fail to provide a durable, lightweight receptacle for receiving the support rail.

It is also desirable to form a receptacle for rail, such that the rail does not have to be attached between base and cushion. Moreover, it is desirable for such receptacle to allow flexion of the rail at its tension point while securable fastening the support rail to the base. In conventional bicycle saddle designs, the support rail extends from the posterior of the base and is attached near the nose of the saddle. In some saddle designs, the rail is affixed at a concavity in the base, extending into the cushion area between the base and cushion. However, this configuration provides inadequate support for the support rail, and does not allow flexion of the support rail at its tension point. During riding, the support rail may oscillate, and flex at its tension point, thereby causing stress along the posterior portion of the support rail. Therefore, a need exists for a lightweight, durable fastening member which attaches the cover to the base of a bicycle saddle, which provides a receptacle for a support rail.

### SUMMARY OF THE INVENTION

Embodiments of the invention solve the need for a lightweight durable fastening member which attaches a cover to a base of a bicycle saddle, and provides a receptacle for a support rail. In a preferred embodiment, a fastening member is attached to a bicycle saddle having a base, a cushion, and a cover. The base has a lower base surface, and an outer lip. The fastening member is attached to the lower base and comprises arm members extending adjacent to the outer lip, a central portion separating the arm members, and a contoured housing member extending from the central portion. The arm members, central portion, and contoured housing member exist as a solid contiguous element. The contoured housing member comprises a receptacle for receiving support rails, and foundation surfaces for attachment of the fastening member to the base. The receptacle extends as a concave channel into the contoured housing member, separated from the foundation surfaces. The cover fits tautly over the base and cushion and is secured to the lower base surface. The cover extends between the fastening member and lower base surface.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a fastening member according to an embodiment of the invention.

FIG. 2 is a front view of the fastening member of FIG. 1.

FIG. 3 is a rear view of the fastening member of FIG. 1.

FIG. 4 is a side view of the fastening member of FIG. 1.

FIG. 5 is a top plan view of the fastening member of FIG. 1.

FIG. 6 is a bottom plan view of the fastening member of FIG. 1.

FIG. 7 is a perspective view of the fastening member attached to a bicycle saddle showing the top of the bicycle saddle, according to an embodiment of the invention.

FIG. 8 is a front view of the fastening member attached to the bicycle saddle, according to the embodiment of FIG. 7.

FIG. 9 is a rear view of the fastening member attached to the bicycle saddle, according to the embodiment of FIG. 7.

FIG. 10 is a top plan view of the fastening member attached to the bicycle saddle, according to the embodiment of FIG. 7.

FIG. 11 is a bottom plan view of the fastening member attached to the bicycle saddle, according to the embodiment of FIG. 7

FIG. 12 is a left side view of the fastening member attached to the bicycle saddle, according to the embodiment of FIG. 7.

FIG. 13 is a right side view of the fastening member attached to the bicycle saddle, according to the embodiment of FIG. 7.

FIG. 14 is a perspective view of the fastening member attached to the bicycle saddle, showing the bottom of the bicycle saddle, according to the embodiment of FIG. 7.

FIG. 15 is a bottom plan view of the bicycle saddle without the fastening member and support rail attached, illustrating the outer lip and lower base surface, according to the embodiment of FIG. 7.

FIG. 16 is a sectional view of the fastening member attached to the bicycle saddle as would be seen from Plane I—FIG. 11, according to the embodiment of FIG. 7.

FIG. 17 is an exploded perspective view showing attachment of the fastening member to the base, according to the embodiment of FIG. 7.

For purposes of clarity and brevity, like elements and components will bear the same designations and numbering throughout the Figures.

### DETAILED DESCRIPTION

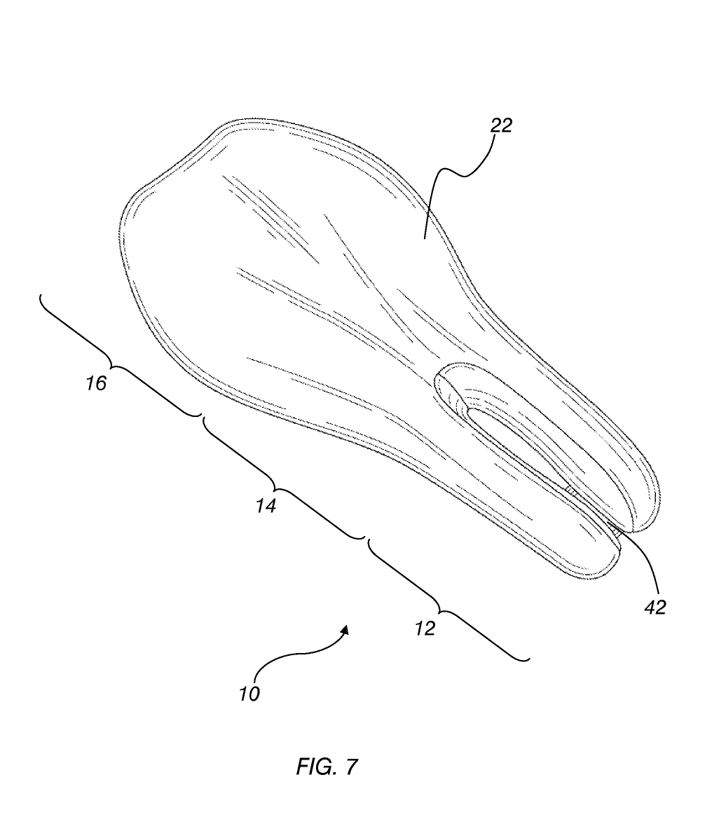

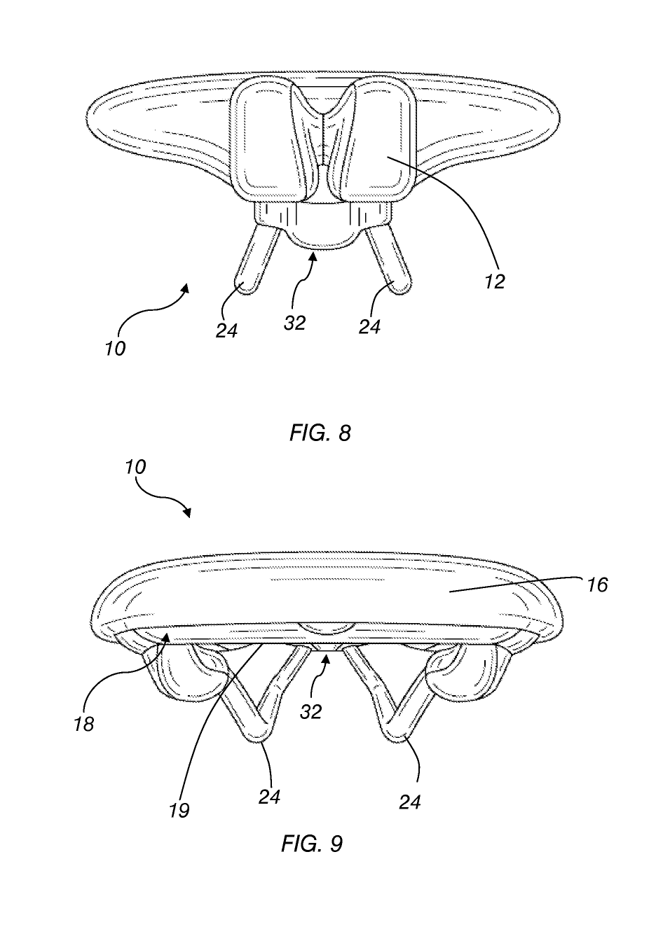

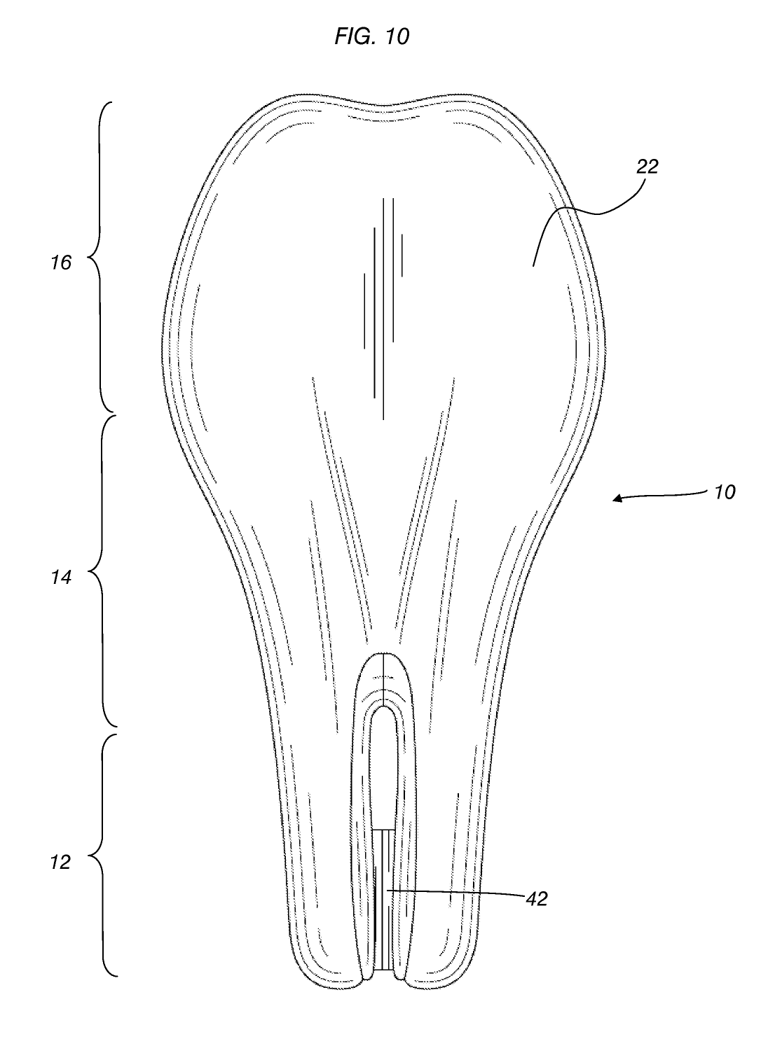

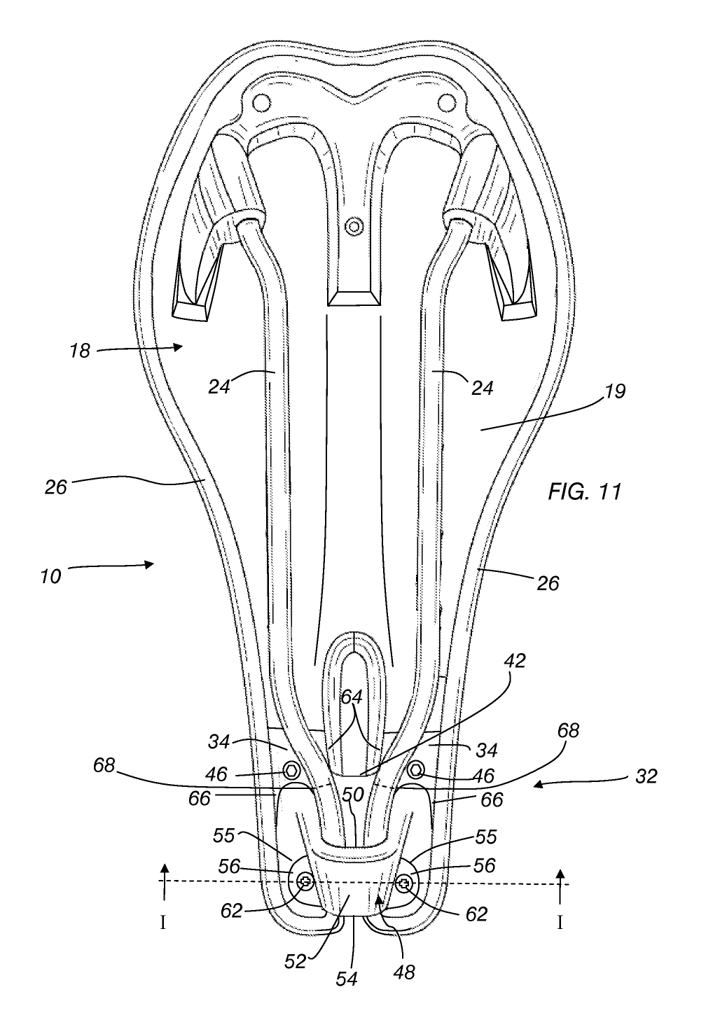

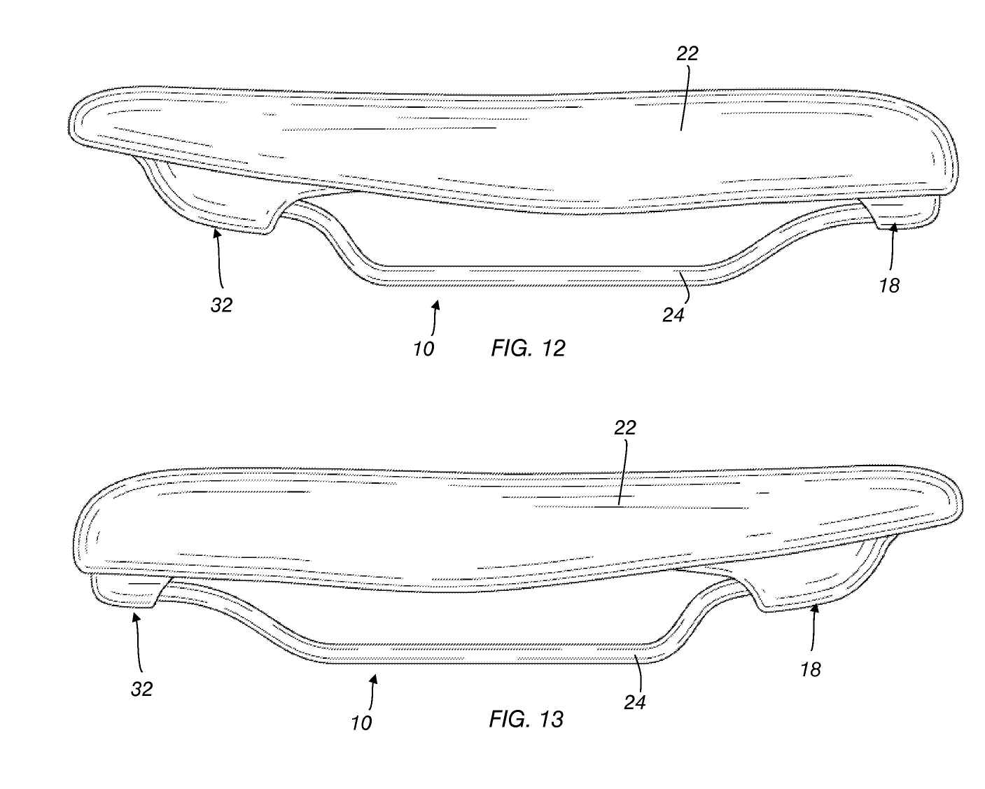

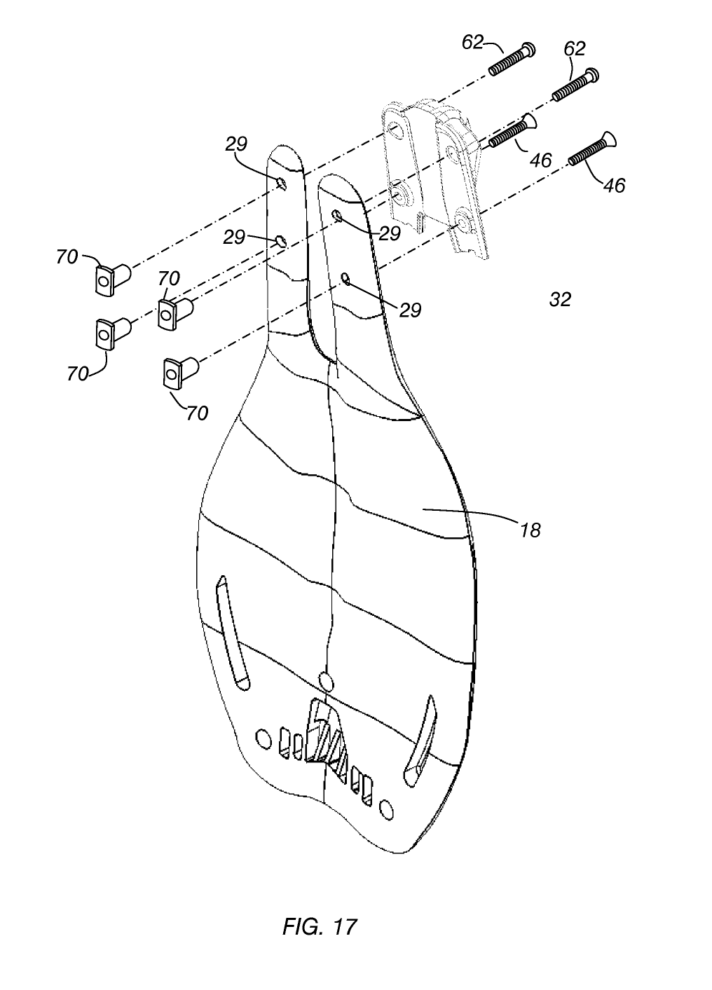

According to an exemplary embodiment, a fastening member 32 is adapted to fit a bicycle saddle 10, as shown in the accompanying drawings. The bicycle saddle 10 of the preferred embodiment illustrates a saddle with bifurcated nose, however the fastening member 32 may be adapted to other types of saddles (such as a bicycle saddle with a single nose). The bicycle saddle 10 of the preferred embodiment comprises a base 18, a cushion 20, and a cover 22, as shown in FIGS. 7-17. According to FIG. 11, the bicycle saddle 10 is defined by a nose portion 12, a medial portion 14, and a rear portion 16.

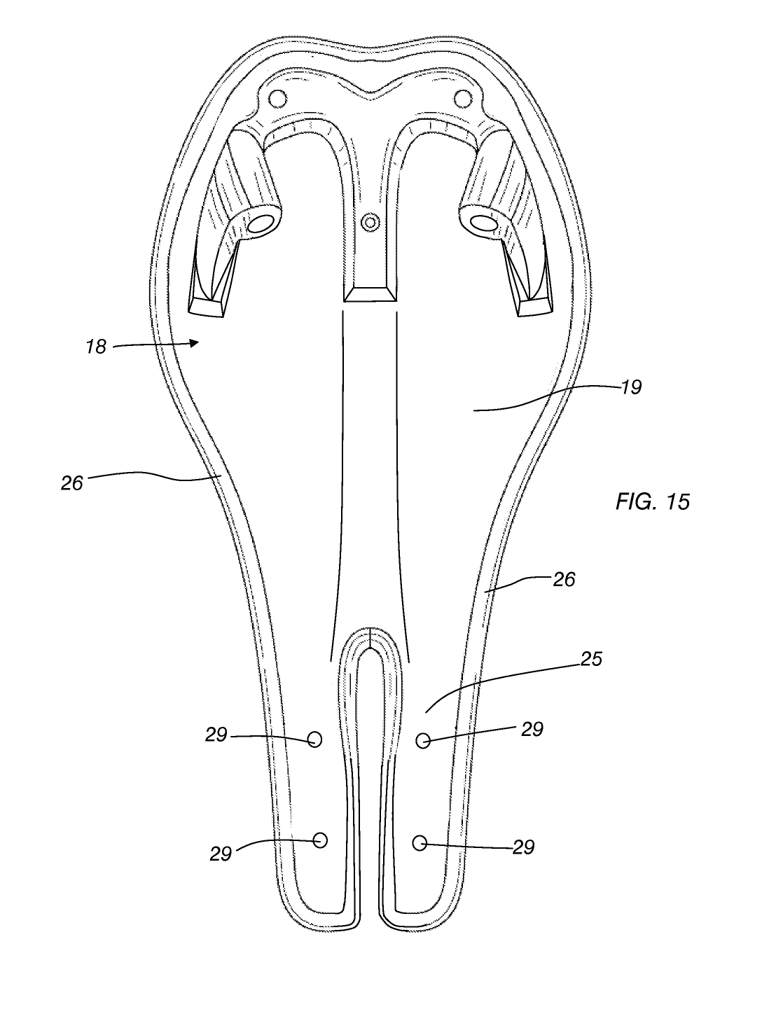

The base 18 defines a solid piece of injection molded polypropylene, which forms the foundation for the bicycle saddle 10. The lower base surface 19 is illustrated in FIG. 15. As shown in FIG. 15, the lower base surface 19 is contoured such that it has an outer lip 26. The outer lip 26 extends around the periphery of the lower base surface 19. The lower base surface 19 has receiving holes 29 located near the nose portion 12, as shown in FIG. 15.

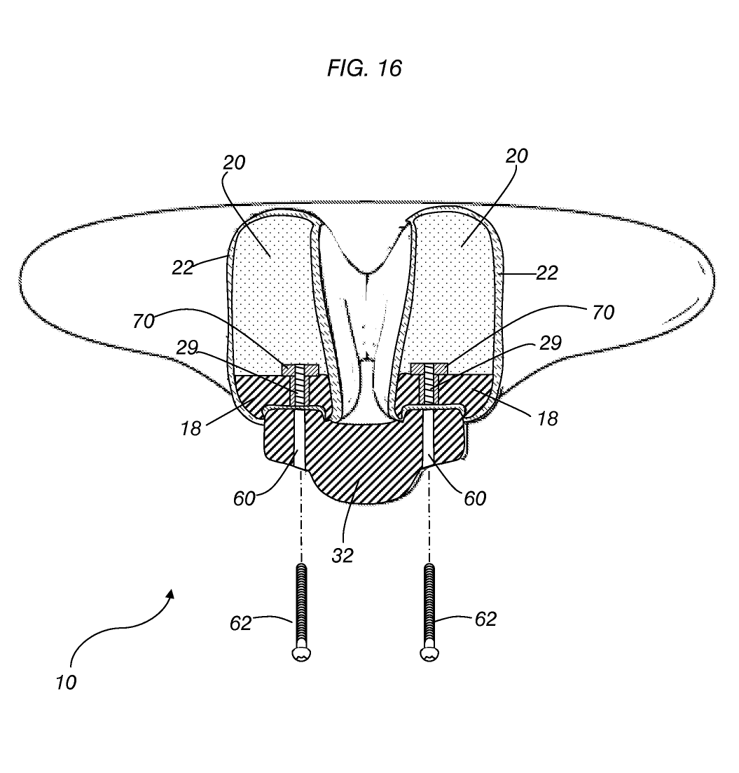

The cushion 20 of the preferred embodiment is densely packed, closed cell foam, which provides support for the rider. The cushion 20 is positioned between the base 18 and the cover 22, as shown in FIG. 16. The cushion may be contoured for rider comfort, as shown in FIGS. 7-17.

The cover 22 of the preferred embodiment is a form-fitted piece of nylon. The cover 22 is shaped such that it fits tautly over the cushion 20 and extends over the outer lip 26, as shown in FIG. 16.

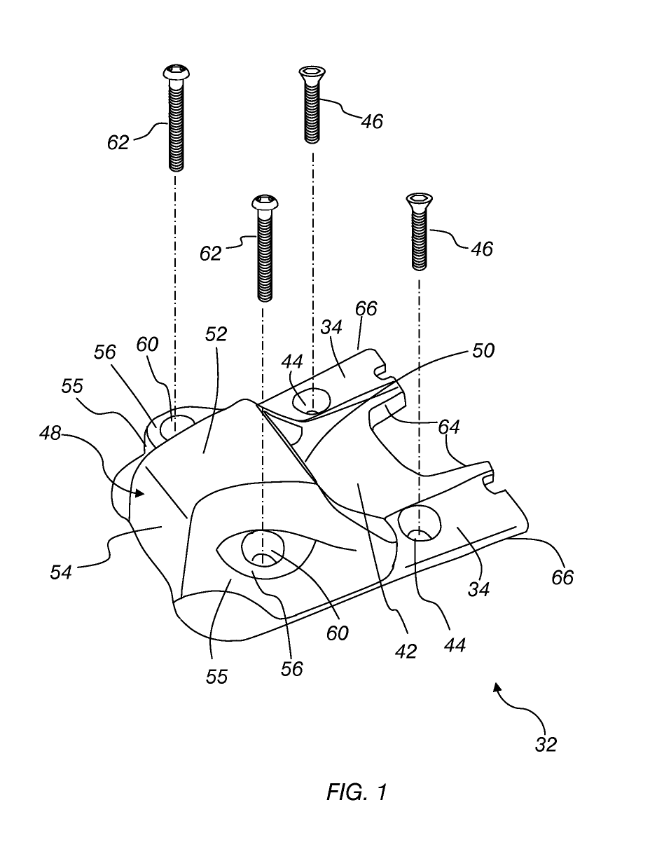

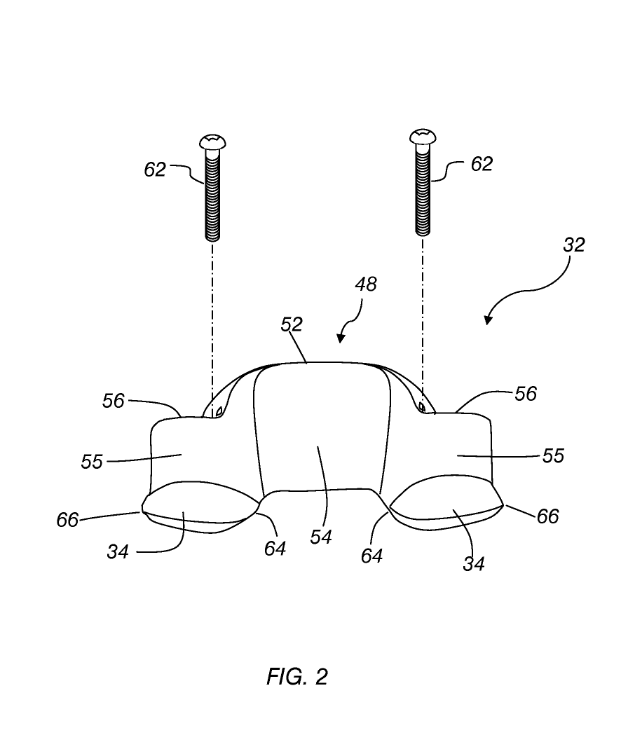

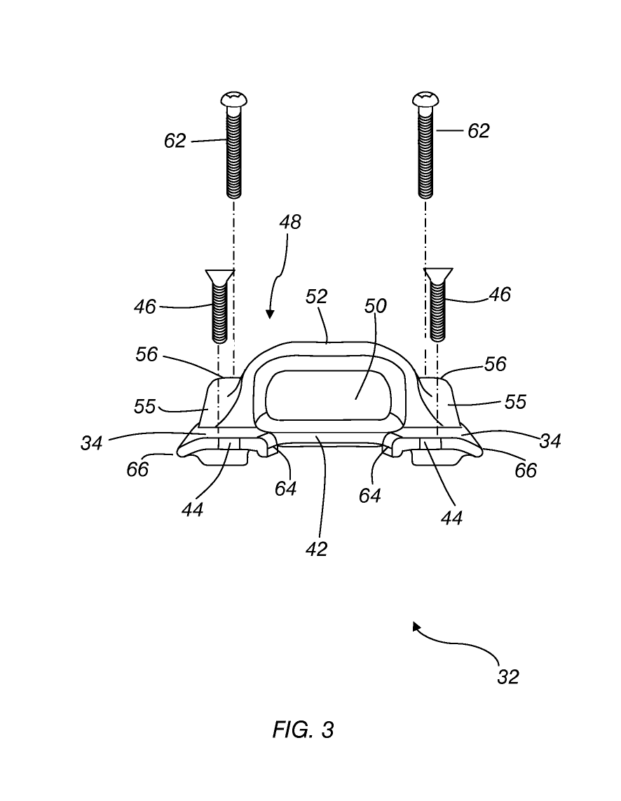

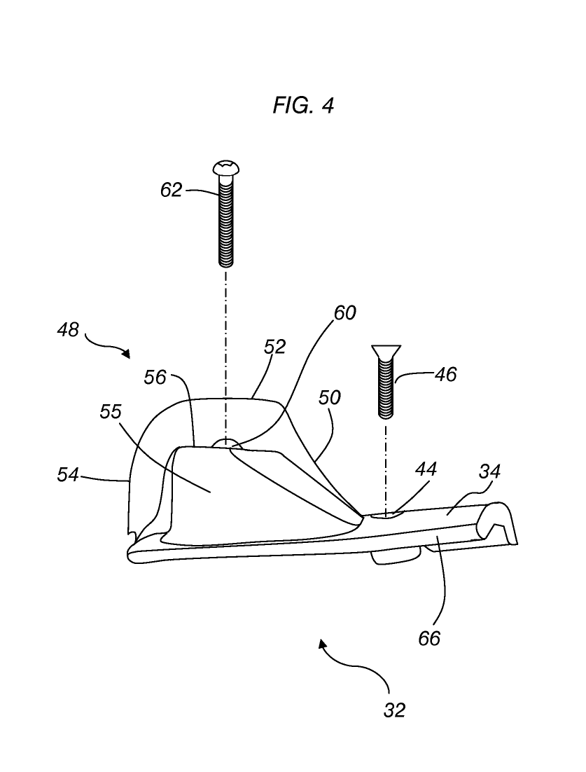

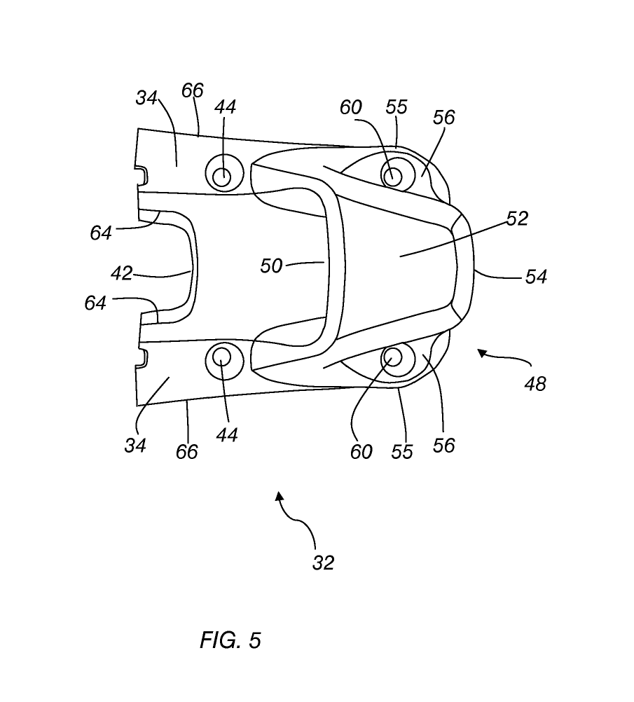

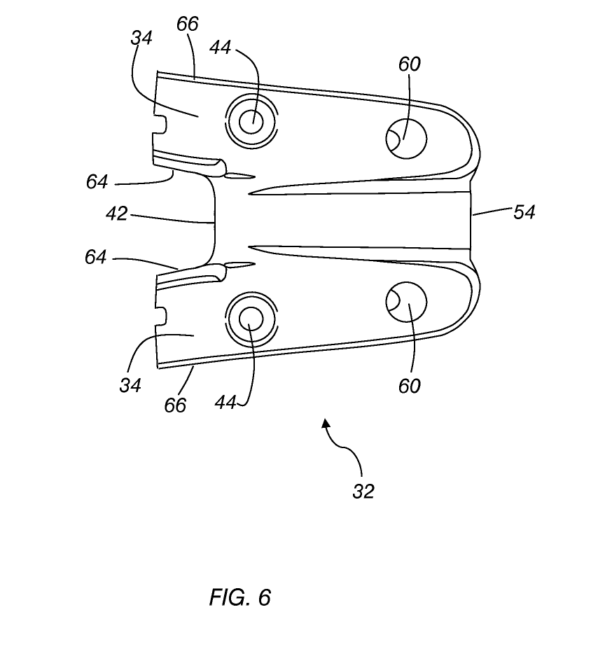

The fastening member 32 is constructed of a solid resilient material, which fixedly secures the cover 22 to the base 18. In the preferred embodiment, the fastening member 32 is a solid contiguous piece of injection molded polypropylene as shown in FIGS. 1-6. The fastening member 32 extends from the nose portion 12 towards the medial portion 14 of the bicycle saddle 10. According to FIGS. 1-6, the fastening member 32 comprises arm members 34, a central portion 42, and a contoured housing member 48. The arm members 34 extend longitudinally towards the medial portion 14. The arm members 34 have arm outer surfaces 66 and arm inner surfaces 64. The width of the arm members 34 is such that the arm outer surfaces 66 and arm inner surfaces 64 sit flush with the outer lip 26 as shown in FIGS. 11, 14, 15, 16.

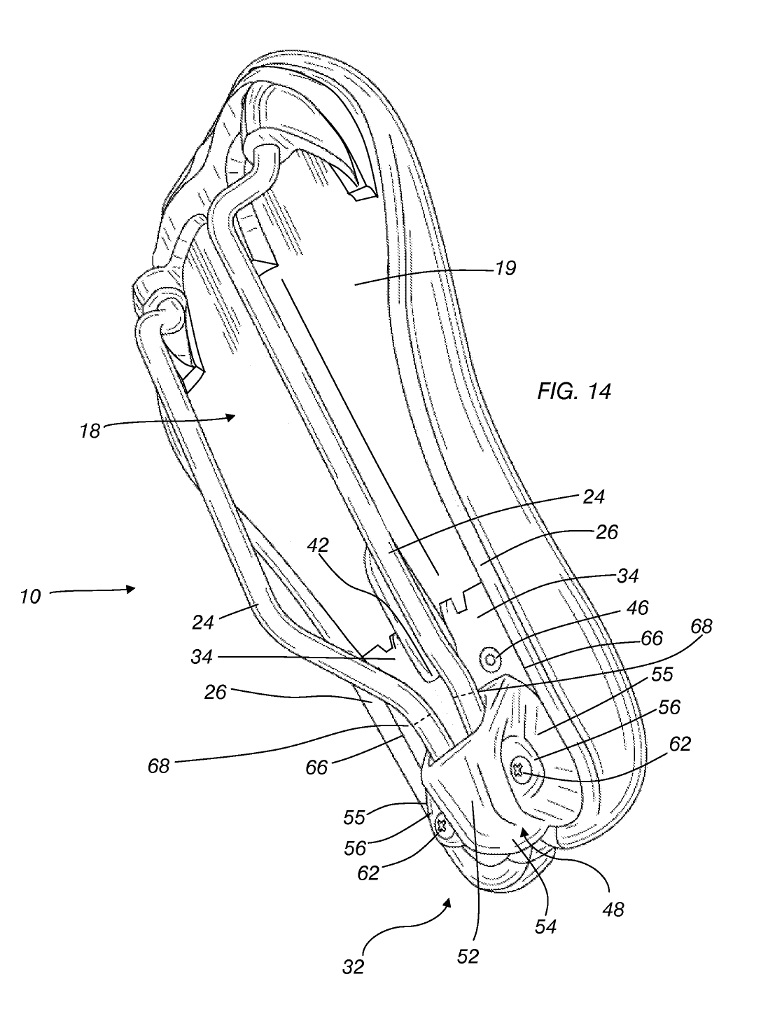

In the preferred embodiment, the central portion 42 extends between the arm members 34, at the nose portion 12. The central portion 42 fits into the nose recess 25 as shown in FIGS. 11, 14.

In accordance with FIGS. 1-6, the contoured housing member 48 comprises a front surface 54, a housing lower surface 52, a receptacle 50, and foundation members 55. The front surface 54 is located proximate to the nose of the bicycle and extends downwardly from the lower base surface 19 a distance, forming a housing lower surface 52. The front surface 54 of the preferred embodiment has a height of approximately 15 mm, as measured from the lower base surface 19. The portion of the housing lower surface 52 closest to the nose section 12 tapers into the front surface 54, as shown in FIGS. 1-6. A receptacle 50 opposes the front surface 54, and forms a concave channel with a continuous, smooth surface for receiving a support rail 24.

The foundation members 55 have foundation surfaces 56, which exist at height of less than that of the height of the front surface 54, as measured from the lower base surface 19. In the preferred embodiment, the height of the foundation surfaces 56 are approximately 10 mm, as measured from the lower base surface 19. The edges of the front surface 54, housing lower surface 52, receptacle 50, foundation members 55, and foundation surfaces 56 are rounded, in accordance with FIGS. 1-6.

The fastening member 32 fits over the cover 22, securely fastening the cover 22 to the lower base surface 19. One or more support holes 44 are located on the arm lower surfaces, and extend through the arm members 34. Support screws 46 are inserted through the support holes 44 and into support nuts 70, which are inserted into the receiving holes 29. According to the preferred embodiment, the support screws 46 are flat head hexagon socket countersunk screws. In the preferred embodiment, the support screws 46 have a length of approximately 10 mm, and a diameter of approximately ⅛″. One or more foundation holes 60 are located on the foundation surfaces 56, and extend through the fastening member 32. Foundation screws 62 are inserted through the foundation holes 60 and into support nuts 70, which are inserted into the receiving holes. According to the preferred embodiment, the foundation screws 62 are button head hexagon screws with a distance of at least greater than height from the lower base surface 19 to the foundation surfaces 56. In the preferred embodiment, the foundation screws 62 have a length of approximately 17 mm, and a diameter of approximately ⅛″. Support nuts 70 are longitudinally extending threaded elements, constructed of steel.

According to the preferred embodiment, the cover 22 fits tautly over the base 18 and cushion 20 and is secured to the lower base surface 19 as shown in FIG. 16. The cover 22 extends between the fastening member 32 and lower base surface 19. The fastening member 32 prevents the cover 22 from tearing or protruding from the lower base surface 19. The fastening member 32 receives the support rail 24.

The support rail 24 is a longitudinally extending element extending between the rear portion 16 and nose portion 12 of the bicycle saddle 10. The support rail 24 is constructed of lightweight aluminum has a tension point 68 near the nose portion 12, as shown in FIGS. 11, 14. During riding, the support rail 24 may flex at tension point 68. As shown in FIGS. 11, 14, the tension point 68 in the preferred embodiment is the point at which the support rail 24 begins downward curvature. The support rail 24 is positioned into the receptacle 50, such that tension point 68 is posterior of the entrance of support rail 24 into the receptacle 50. The foundation holes 60 and foundation screws 62 are located anterior of the tension point 68, as shown in FIGS. 11, 14. The support holes 44 and support screws 64 are located posterior of the tension point 68, as shown in FIGS. 11, 14.

Although the preferred embodiment herein is set forth in sufficient detail, other structures embodying the invention are contemplated. For example, the components may be constructed of differing materials. The base 18 and fastening member 32 may be constructed of a number of resilient materials such as polypropylene, polurethane, polymer, or nylon. Alternatively, the bicycle saddle 10 may have a single nose or have differing dimensions from those shown in the drawing figures herein.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A bicycle saddle fastening assembly, comprising:
a. a base comprising a lower base surface and outer lip, said base defined by a rear portion, a medial portion, and a nose portion;
b. a cushion;
c. a cover extending over said cushion, said outer lip, and onto said lower base surface;
d. a fastening member attached to said lower base surface at said nose portion, said fastening member comprising arm members, a central portion, and a contoured housing member, said fastening member existing as a solid contiguous piece of resilient material which securably fastens said cover to said lower base surface;
e. a support rail comprising a tension point, wherein said support rail extends longitudinally between said rear portion and said nose portion;
f. wherein said arm members extend longitudinally towards said medial portion and comprise support holes located posterior of said tension point;
g. wherein said central portion extends between said arm members;
h. wherein said contoured housing member comprises a front surface, a housing lower surface, a receptacle, and foundation members;
i. wherein said receptacle opposes said front surface and forms a concave channel with a continuous smooth surface for receiving said support rail;
j. wherein said foundation members comprise foundation holes separated from said receptacle, and located anterior of said tension point;
k. support screws inserted through said support holes; and
l. foundation screws inserted through said foundation holes.

2. The bicycle saddle fastening assembly of claim 1, wherein said outer lip extends around the periphery of said lower base surface.

3. The bicycle saddle fastening assembly of claim 1, wherein said base has receiving holes located at said nose portion.

4. The bicycle saddle fastening assembly of claim 3, wherein said support screws are inserted through said support holes and into support nuts inserted into said receiving holes.

5. The bicycle saddle fastening assembly of claim 3, wherein said foundation screws are inserted through said foundation holes and into support nuts inserted into said receiving holes.

6. The bicycle saddle fastening assembly of claim 1, wherein said arm members further comprise arm outer surfaces and arm inner surfaces.

7. The bicycle saddle fastening assembly of claim 6, wherein a width of said arm members is such that said arm outer surfaces and said arm inner surfaces sit flush with said outer lip.

8. The bicycle saddle fastening assembly of claim 1, wherein said central portion fits into a nose recess located at said lower base surface.

9. The bicycle saddle fastening assembly of claim 1, wherein said front surface extends downwardly from said lower base surface into said housing lower surface.

10. The bicycle saddle fastening assembly of claim 1, wherein said foundation members have foundation surfaces approximately perpendicular with said lower base surface.

11. The bicycle saddle fastening assembly of claim 10, wherein said foundation surfaces have a foundation height of less than that of a front surface height, as measured from said lower base surface.

12. The bicycle saddle fastening assembly of claim 1, wherein edge surfaces of said front surface, said housing lower surface, and said receptacle, and said foundation members are rounded.

13. The bicycle saddle fastening assembly of claim 1, wherein said cover extends between said fastening member and said lower base surface.

14. The bicycle saddle fastening assembly of claim 1, wherein said receptacle forms an opening facing said rear portion descending into said central portion.

15. The bicycle saddle fastening assembly of claim 14, wherein said central portion extends into said support arms.

16. The bicycle saddle fastening assembly of claim 1, wherein a receptacle width is approximately the same as a central portion width.

17. The bicycle saddle fastening assembly of claim 1, wherein said support arms comprise a plurality of support holes.

18. The bicycle saddle fastening assembly of claim 17, further comprising a plurality of support screws extending through said support holes.

19. A fastening member for a bicycle saddle, comprising:
a. arm members comprising at least one support hole, said arm members having a substantially planar longitudinally extending surface;
b. a central portion separating said arm members;
c. a contoured housing member extending upward from said central portion, comprising a front surface, a housing lower surface, foundation members; and a receptacle;
d. support screws;
e. foundation screws;
f. wherein said front surface opposes said receptacle;
g. wherein said receptacle forms an opening for reception of a support rail;
h. wherein said foundation members comprise foundation holes separated from said receptacle;
i. wherein said fastening housing member has a substantially flat lower surface for attachment to a bicycle saddle;
j. wherein said arm members, said central portion, and said contoured housing member is a solid contiguous element of resilient material; and
k. wherein said fastening member is secured to said bicycle saddle by said support screws and said foundation screws.

20. A fastening member for a bicycle saddle, comprising:
a. arm members comprising at least one support hole, said arm members having a substantially planar longitudinally extending surface;
b. a central portion separating said arm members having a substantially planar longitudinally extending surface;
c. a contoured housing member extending upward from said central portion, comprising a front surface, a housing lower surface, foundation members;
and a receptacle;
d. support screws;
e. foundation screws;
f. wherein said front surface opposes said receptacle and tapers into said housing lower surface;
g. wherein said receptacle forms an opening for reception of a support rail, said receptacle forming a concave channel with a continuous, smooth surface;
h. wherein said foundation members comprise foundation holes located on foundation surfaces, said foundation holes separated from said receptacle;
i. wherein said fastening housing member has a substantially flat lower surface for attachment to a bicycle saddle;
j. wherein said arm members, said central portion, and said contoured housing member is a solid contiguous element of resilient material; and
k. wherein said fastening member is secured to said bicycle saddle by said support screws and said foundation screws.
